(19) United States
(12) Patent Application Publication
(10) Pub. No.: US 2006/0218486 A1
(43) Pub. Date: Sep. 28, 2006

(54) Method and system for probability-based validation of extensible markup language documents

(75) Inventor: Luyin Zhao, White Plains, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/566,824

(22) PCT Filed: Jul. 30, 2004
(86) PCT No.: PCT/IB04/51348

§ 371 Date: Jan. 31, 2006

Related U.S. Application Data
(60) Provisional application No. 60/492,654, filed on Aug. 5, 2003.

(51) Int. Cl. G06F 17/00

(52) U.S. Cl. 715/513

(57) ABSTRACT

A system and method are disclosed to that use a probability-based validation method that looks ahead/back when an incorrect XML tag is found instead of notifying a user about the error immediately. The system and method can provide probability-based values that can be used to point out error locations in a chunk of XML code and indicate most likely error location(s) using probability values.

In general, the invention relates to extensible markup language programming. More specifically, the invention relates to a method and system for probability-based validation of extensible markup language documents.

Extensible Markup Language (XML) was designed to improve functionality of the World Wide Web (WWW) by providing more flexible and adaptable information identification. XML is identified as extensible because it is not a fixed format, such as Hyper Text Markup Language (HTML). HTML is a single, predefined markup language. XML is a “metalanguage”, that is XML is a language for describing other languages. XML allows a user to design her own customized markup languages for an unlimited amount of documents. XML can be utilized in this manner because XML is written in Standard Generalized Markup Language (SGML), the international standard “metalanguage” for text markup systems (ISO 8879:1985).

XML was designed to allow straightforward use of SGML on the Web, such as defining document types, enabling simplified authorship and management of SGML-defined documents, and allowing ease of transmission and sharing of the documents across the Web. XML is described in the XML specification and defines a dialect of SGML. One of the goals in developing XML was to produce a generic SGML that would be received and processed on the Web, similar to HTML. Therefore, XML was designed, among other design characteristics, to allow for ease of implementation and interoperability with both SGML and HTML. XML was not designed solely for Web page application. XML was designed to be utilized to store many different types of information. An important XML use includes encapsulating information in order to pass the information between various computing systems that may otherwise not be capable of communicating.

XML allows groups or organizations to create their own customized markup applications for exchanging information in a domain, for example chemistry, electronics, finance, engineering, and the like. Each customized markup application is termed a specific XML Schema of the W3C XML Schema Definition Language. The XML Schema defines what the hierarchical structure, also referred to as tree, of XML documents would be and whether individual elements/attributes should possess predefined values, what constraints the XML documents carry, and the like.

XML Schema's can be used to create, for example, various databases that can be accessed/transmitted over a network to heterogeneous system. In the creation of a database, using a data model in conjunction with integrity constraints can ensure that the structure and content of the data meet the requirements. XML files are designed to be easy to read and edit. They are also designed for easy data exchange among different systems and different applications. However, both of these factors can work against the need for data to be in a specific format. Validation enables confirmation that XML data follows a specific predetermined structure so that an application can receive it in a predictable way. This structure against which the data is validated can be provided in a number of different ways, including Document Type Definitions (DTDs) and XML schemas.

A schema document is the document containing the structure, and the instance document is the document containing the actual XML data. Essentially, a schema document is simply an XML document with predefined elements and attributes describing the structure of another XML document. All XML documents are built on elements. Defining an element in a schema document is a matter of naming it and assigning it a type. This type designation can reference a custom type, or one of the built-in types listed in the XML Schema Recommendation.

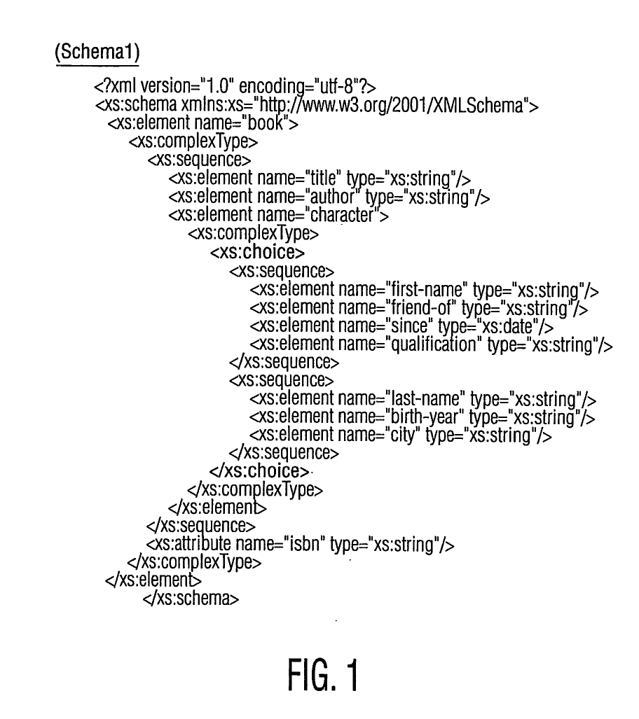

One important issue in this environment is that XML Schema allows making choices for a sub-element using <choice> tag. FIG. 1 is a diagram of a block of code illustrating an XML Schema that uses a <choice> to specify the content of “character.” This means that with <choice></choice> tag pairs, one of two <sequence></sequence> tag pairs can be chosen.

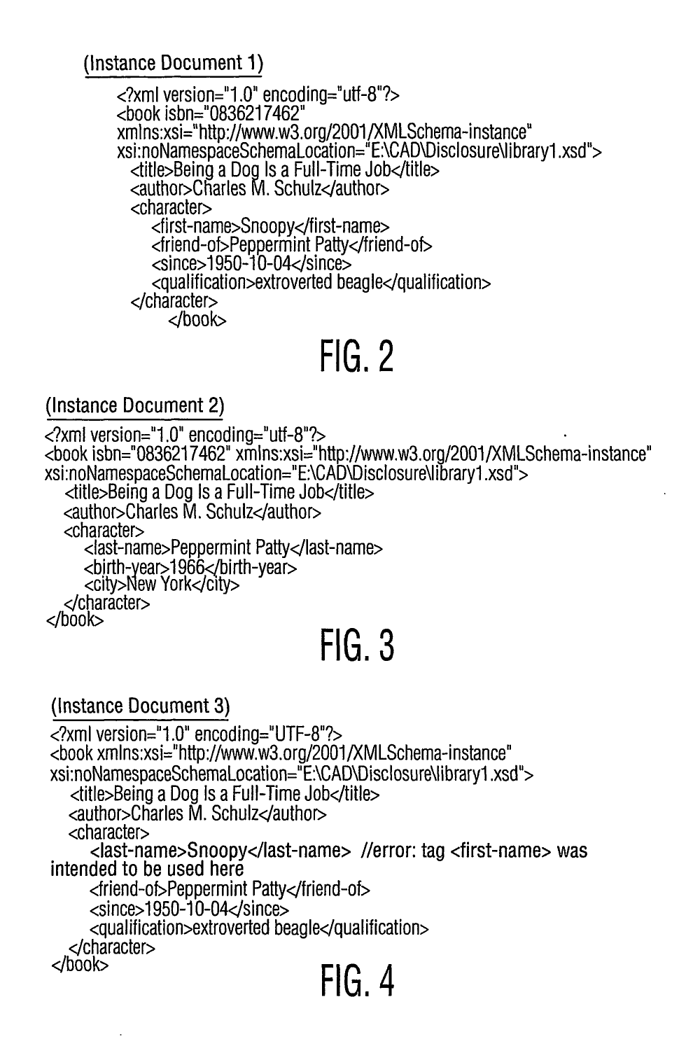

FIGS. 2 and 3 show examples of two (instance) documents that are both valid against the XML Schema shown in FIG. 1.

Conventional validation engines are known that will provide a validation result. The validation result will indicate whether the instance document is valid against the particular XML Schema or not. However, when large schemas with multi-level sub-trees are implemented a small error may lead to a very confusing validation result and require a great deal effort to debugging the instance document.

For example, XML schemas may be used to represent DICOM (Digital Imaging and Communication in Medicine) standard information. When such a DICOM XML document is created, an appropriate XML Schema can be used to validate this XML document. For very complicated XML Schema representations like those for the DICOM standard, it is essential to do precise validation in order to find possible errors in a very complicated XML document. Conventional validation methods don't work precisely while determining the correctness of XML element under the circumstance of making choices using <choice> tag.

It would be desirable, therefore, to provide a method and system that would overcome these and other disadvantages.

One aspect of the invention provides a system and method that use a probability-based validation method that looks ahead/back when an incorrect XML tag is found instead of notifying a user about the error immediately. This method is more accurate than conventional validation methods because it offers probability based suggestions in terms of the pointing out error locations by looking at a chunk of XML code and specifying all possible error locations with probabilities.

One embodiment of the present invention is directed to a method for validating code in a mark-up language document. The method includes the steps of providing a schema and an instance document, validating the instance document against the schema, and determining if the instance document contains an error section based upon the validation step. If there is an error, then a determination is made as to whether there are a plurality of logical sections of the schema possibly related to the error section, and determining a probability value for each of the plurality of logical sections that indicates a relationship between the error section and a respective logical section.

Another embodiment of the present invention is directed to a computer readable medium storing a computer program includes: computer readable code for providing a schema, for providing an instance document, for comparing the instance document to the schema, for determining if the instance document contains an error section based upon the comparing step, for if there is an error, determining if there are a plurality of logical sections of the schema possibly related to the error section, and for determining a probability value for each of the plurality of logical sections that indicates a relationship between the error section and a respective logical section.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

FIG. 1 is a diagram of a block of code illustrating an XML schema;

FIG. 2 is a diagram of a block of code illustrating one example of an instance document valid against the XML schema of FIG. 1;

FIG. 3 is a diagram of a block of code illustrating yet another example of an instance document valid against the XML schema of FIG. 1;

FIG. 4 is a diagram of a block of code illustrating an example of a validation report for an instance document that is not valid against the XML schema of FIG. 1; and

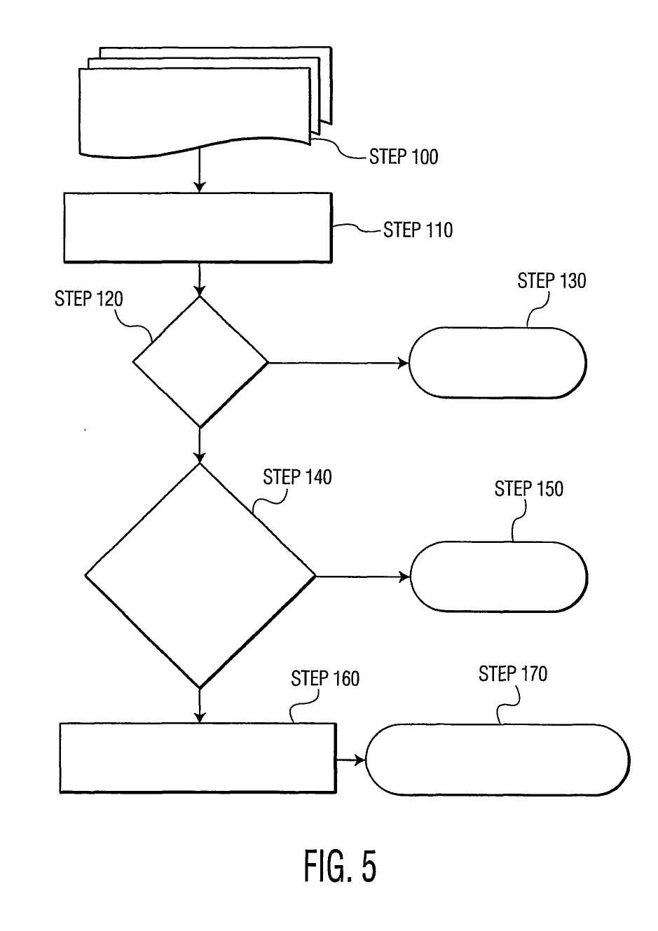

FIG. 5 is a flow diagram of a method embodiment in accordance with the present invention.

To illustrate the embodiments of the present invention, one disadvantage of the conventional validation engines will be discussed. FIG. 4 is a diagram of a block of code illustrating an example of an instance document that is not valid against the XML schema of FIG. 1.

If Instance Document 1 (FIG. 2) and instance Document 3 (FIG. 4) are compared it can be seen that Instance Document 3 contains a typographical error, i.e., “last-name” as opposed to “first-name.”

It is likely that the author of Instance Document 3 intended to use “first-name” (for convenience, this is noted in FIG. 4 with an “error: tag”) as appeared in Document 1. If Instance Document 3 is validated using a conventional validation engine, the validation results will show that a tag “<birth-year>” should appear in the place of tag “<friend-of>” despite of the XML author's intention. Conventional validation engines do not look ahead to determine whether Instance Document 3 should conform to the second <sequence></sequence> within <choice></choice> tag pairs as shown in Schema 1 (FIG. 1). This is because the <character> element in Instance Document 3 starts with a tag <last-name> so conventional validation engines will indicate that the second <sequence></sequence> within the <choice></choice> tag pairs should be followed.

In this regard, conventional XML validation engines for validating XML documents (e.g. XML Spy, eXcelon Stylus Studio and Xerces) would produce a validation output indicating the second <sequence></sequence> should have been followed. However, it is likely that such a validation result is not what the author actually intended. When a very complicated XML documents is to be validated, such validation outputs would be confusing and only increase the complexity of finding real errors in the instance document.

FIG. 5 is a flow diagram depicting an exemplary embodiment of code on a computer readable medium in accordance with the present invention. FIG. 5 details an embodiment of a method for improving validation an extensible markup language documents.

The method begins at step 100 with a user wishing to validate an instance document against a schema. At step 110, the instance document is validated against an XML schema. If no error is detected during this comparison (step 120), the instance document is valid against the schema (step 130). If an error is detected in step 120, it is determined whether multiple logical sections are present in the schema. For example, in the schema shown in FIG. 1, the <choice> </choice> tag pair contains two <sequence></sequence> groups. Each of the <sequence></sequence> groups is a logical section. If the schema did not contain any <choice> </choice> tag pair having alternative <sequence></sequence> group, an error report would be provided in step 150.

At block 160, the method includes a “look-ahead/back” and a “probability-based” validation process. While conventional validation engines merely find the first potential incorrect tag of an XML document against an XML schema, the method looks ahead and/or back at other/remaining logical sections of an XML chunk within various elements (e.g., <choice></choice> tag pairs). A probability for each possible error location is determined.

In this regard, when an inconsistency or mistake in the instance document is detected, the probability-based process block 140 compares the chunk of XML code that contains errors with all choices within, for example, the <choice> </choice> tag pairs and calculates error probabilities for each choice.

In this embodiment, the formula for calculating probability is:

Probability=# of correct tags that appear in the instance document as compared to a logical section of the Schema/total# of tags within the logical section For example, the following is a chunk of XML code (considering the XML schema of FIG. 1) that contains an error as highlighted:

<last-name>Snoopy</last-name>
<friend-of>Peppermint Patty</friend-of>
<since>1950-10-04</since>
<qualification>extroverted beagle</qualification>

As discussed above, there are two logical sections of the Schema shown in FIG. 1, i.e., the first and second <sequence></sequence> groups. When the above chuck of XML code is compared with the first <sequence></sequence> within <choice></choice> tag pairs of FIG. 1, an error probability of ¾ is determined, i.e., this chuck contains three correct tags out of four total. When the above chuck of XML code is compared with the second <sequence></sequence> within <choice> </choice> tag pairs of FIG. 1, an error probability of ⅓ is determined, i.e., this chuck contains one correct tag out of three.

When presented with two probability values of ¾ and ⅓, the XML document author can properly judge the error location, since ¾>⅓, it is more likely that the above XML code should conform to the first <sequence></sequence> tag pairs in the XML Schema of FIG. 1.

This probability information may be included in the output of a validation output report (step 170) from a validation engine in accordance with embodiments of the present for the user to review. For example, when an error is encountered, the validation engine may read all choices within, e.g., the <choice></choice> tag pairs and calculate probabilities for each choice and print/display these values to the user for judgment. The validation engine may also automatically predict for the user which logical section the error code should conform with based upon the higher probability factors.

The functional operations associated with the method 100, as described above, may be implemented in whole or in part in one or more software programs stored in a memory and executed by a processor. The software programs may be part of, or accessible by, an XML document validation engine.

The processor may include an information interface to a network. The network may be, for example, a global computer communications network such as the Internet, a wide area network, a metropolitan area network, a local area network, a cable network, a satellite network or a telephone network, as well as portions or combinations of these and other types of networks. The information interface maybe a server and/or client machine coupled to the network.

The process may access schema and instance documents that are stored in the memory or via the network and/or input though a memory interface such as a CD or floppy disk interface.

In other embodiments, hardware circuitry may be used in place of, or in combination with, software instructions to implement aspects of the method 100.

The above-described methods and implementation embodiments of the present invention are example methods and implementations. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its essential characteristics. The described embodiments are to be considered in all respects only as illustrative and not restrictive.

1. A method [FIG. 5] for validating code in a mark-up language document, the method comprising:
providing a schema;
providing an instance document;
comparing the instance document to the schema;
determining if the instance document contains an error section based upon the comparing step;
if there is an error, determining if there are a plurality of logical sections of the schema possibly related to the error section; and
determining a probability value for each of the plurality of logical sections that indicates a relationship between the error section and a respective logical section.

2. The method of claim 1 wherein the schema comprises an extensible markup language A ) schema.

3. The method of claim 2 wherein the plurality of logical sections include sub-elements of a <choice> </choice> tag pair.

4. The method of claim 3 wherein the sub-elements at least two <sequence><sequence> groups.

5. The method of claim 1 further comprising the step of providing the probability value for each of the plurality of logical sections to a user.

6. The method of claim 1 further comprising the step of predicting which of the plurality of logical sections the error section should conform to based upon the probability values for each of the logical sections.

7. The method of claim 1 wherein the probability value for each of the plurality of logical sections is based upon a number of correct tags that appear in the error section as compared to a respective logical section of the schema divided by a total number of tags within the respective logical section.

8. A computer readable medium [see FIG. 5] storing a computer program comprising:
computer readable for providing a schema;
computer readable for providing an instance document;
computer readable for comparing the instance document to the schema;
computer readable for determining if the instance document contains an error section based upon the comparing step;
computer readable for if there is an error, determining if there are a plurality of logical sections of the schema possibly related to the error section; and
computer readable for determining a probability value for each of the plurality of logical sections that indicates a relationship between the error section and a respective logical section.

9. The computer readable medium of claim 8 wherein the schema comprises an extensible markup language (XML) schema.

10. The computer readable medium of claim 9 wherein the plurality of logical sections include sub-elements of a <choice> <choice> tag pair.

11. The computer readable medium of claim 10 wherein the sub-elements at least two <sequence></sequence> groups.

12. The computer readable medium of claim 8 further comprising computer readable code for providing the probability value for each of the plurality of logical sections to a user.

13. The computer readable medium of claim 8 further comprising computer readable code for predicting which of the plurality of logical sections the error section should conform to based upon the probability values for each of the logical sections.

14. The computer readable medium of claim 11 wherein the probability value for each of the plurality of logical sections is based upon a number of correct tags that appear in the error section as compared to a respective logical section of the schema divided by a total number of tags within the respective logical section.

15. A device [see FIG. 5] for validating code in a mark-up language document, the device comprising:
an interface for receiving a schema and an instance document;
a memory; and
a processor coupled to the interface and the memory, wherein the processor is arranged execute code stored in the memory to validate the instance document against the schema, determine if the instance document contains an error section based upon the comparison, if there is an error, determine if there are a plurality of logical sections of the schema possibly related to the error section, and determine a probability value for each of the plurality of logical sections that indicates a relationship between the error section and a respective logical section.

16. The device of claim 15 wherein the schema comprises an extensible markup language (XML) schema.

17. The device of claim 16 wherein the plurality of logical sections include sub-elements of a <choice> </choice> tag pair.

18. The device of claim 17 wherein the sub-elements at least two <sequence></sequence> groups.

19. The device of claim 15 further comprising a display and wherein the processor is further arranged execute code to provide the probability value for each of the plurality of logical sections to a user.

20. The device of claim 15 wherein the processor is further arranged execute code to predict which of the plurality of logical sections the error section should conform to based upon the probability values for each of the logical sections.

21. The device of claim 15 wherein the probability value for each of the plurality of logical sections is based upon a number of correct tags that appear in the error section as compared to a respective logical section of the schema divided by a total number of tags within the respective logical section.
